(19) United States
(12) Patent Application Publication
(10) Pub. No.: US 2025/0282104 A1
(43) Pub. Date: Sep. 11, 2025

(54) CHAMBER MACHINE WITH CUTTING DEVICE AND METHOD FOR CUTTING OFF A BAG NECK

(71) Applicant: MULTIVAC SEPP HAGGENMÜLLER SE & CO. KG, Wolfertschwenden (DE)

(72) Inventors: Alexander HIRSCHAUER, Leutkirch (DE); Florian FRÜHSAMMER, Kempten (DE); Rainer HÄRING, Lauben (DE); Jonas FRIEDL, Peiting (DE); Maximilian BRUNNER, Westerheim (DE)

(73) Assignee: MULTIVAC SEPP HAGGENMÜLLER SE & CO. KG, Wolfertschwenden (DE)

(21) Appl. No.: 19/070,958

(22) Filed: Mar. 5, 2025

(30) Foreign Application Priority Data
Mar. 5, 2024 (DE) 102024106240.1

(51) Int. Cl. B29C 65/00

(52) U.S. Cl. CPC B29C 66/849; B29C 66/02241; B29C 66/034

(57) ABSTRACT

A chamber machine for cutting to length a bag filled with a product comprises at least one cutting device for severing an unnecessary bag neck and mutually spaced clamping devices for clamping a bag portion. The cutting device is positioned between the clamping devices so that severing of the bag neck can be carried out by the cutting device within the bag section clamped by the spaced clamping devices. The chamber machine further has at least one tensioning device positioned between the clamping devices for exerting a clamping force on the bag section clamped by the spaced-apart clamping devices.

### CROSS-REFERENCE TO RELATED APPLICATIONS

This application claims foreign priority benefits under 35 U.S.C. § 119 (a)-(d) to German patent application number DE 102024106240.1, filed Mar. 5, 2024, which is incorporated by reference in its entirety.

### TECHNICAL FIELD

The present disclosure relates to a chamber machine. Further, the disclosure relates to a method for separating a superfluous bag neck present on a bag filled with a product.

### BACKGROUND

In practice, semi-automatic chamber machines configured as chamber vacuum sealers are already in use. In these machines, a defined vacuum is generated within a hermetically sealed chamber. This removes the existing atmosphere from the vacuum chamber, the bag inside and the spaces between the packaged goods. Once the chamber has been sealed and ventilated, the result is a vacuum pack that is conventionally designed with a double-seam separation seal. With this type of separation seal, there is a separate, spaced-apart separation seam in addition to the sealing seam. An open bag overhang or a superfluous bag neck can be torn off manually along this separating seam. However, this manual intervention increases the amount of labor required for production.

Apart from the semi-automatic solution described above for cutting off the excess bag overhang, automated chamber machines with cutting knives are also used in practice, which are able to cut off a clamped bag neck directly inside the sealing chamber, allowing the bag filled with product to be shortened to a predetermined size. However, the problem with such cutting knives is that they are not sufficiently reliable for cutting off bag protrusions if the bags are made of an elastic material.

### SUMMARY

A problem underlying the disclosure is to provide a chamber machine and a method for improved cutting to length of bags loaded with product with regard to the problems associated with the prior art described above.

This problem is solved by means of a chamber machine according to the disclosure. The problem is further solved by means of a method according to the disclosure.

The disclosure relates to a chamber machine for cutting to length a bag filled with a product, wherein the chamber machine comprises at least one cutting device for cutting off a superfluous bag neck and mutually spaced clamping devices for clamping a bag section. The cutting device is positioned between the clamping devices so that the neck of the bag can be cut off by means of the cutting device within the bag section clamped by the spaced clamping devices. The chamber machine according to the disclosure further comprises at least one tensioning device positioned between the clamping devices for exerting a tensioning force on the bag section clamped by means of the spaced clamping devices. This allows the clamped bag section to be tensioned for the cutting device so that the cutting device can separate the bag neck from the bag more reliably, even in the event that the bag is made of an elastic material, such as a shrink film. By applying the tensioning force to the clamped bag section, which is fixed on both sides by means of the clamping devices, i.e., the action of the tensioning force on the bag between the clamping bearings, the bag section clamped between the clamping bearings is put under tensile stress, in particular even stretched, so that it can be severed more easily. In other words, the bag section clamped at a distance between the clamping points using the tensioning device according to the disclosure can be stretched. In the process, the elastic bag material of the clamped bag section is elongated under load, i.e., by the action of the tensioning force, which makes it easier to cut.

By means of the tensioning device according to the disclosure, the bag section clamped by means of the clamping devices can be pre-tensioned, in particular stretched, for the cutting process to be carried out by means of the cutting device. In particular, this makes it possible to keep elastic material under tensile stress in such a way that it can be reliably cut to length using the cutting device. This is guaranteed because the forces introduced into the bag material by the tensioning device, which place the bag section under tensile stress, favor the cutting process. This is accompanied by the synergetic effect that the cutting device requires less force to reliably cut off the excess bag neck. This also results in more economical and gentle operation of the cutting device, so that it wears less, resulting in longer service life for the cutting device. This favors an overall more cost-effective operation of the chamber machine.

It is also advantageous that the solution according to the disclosure for cutting the bag to length can be fully automated, i.e., without manual intervention, so that the solution according to the disclosure is generally also better suited for use integrated in a production line. In addition, the solution according to the disclosure offers the advantage that a cut-off line can be produced very close along a sealing seam. In other words, this means that an open bag end can be removed completely, or at least shortened as far as possible, resulting in a hygienically improved bag pack.

According to a variant of the disclosure, it is provided that at least one of the two clamping devices is formed by a sealing bar. In this variant, the sealing bar thus fulfills a dual function in that, on the one hand, it interacts as a clamping device together with the other clamping device for clamping the bag section and, on the other hand, it can be used as a tool for closing the bag. In this embodiment, the bag section is first clamped by the sealing bar and by the other clamping device during a machine cycle of the chamber machine. The bag section thus clamped can then be tensioned using the tensioning device according to the disclosure. When the bag section is clamped, the cutting device is used to cut through the clamped bag material. At the same time as the bag neck is cut or after it has been cut, the sealing bar performs its actual function, namely closing the bag by producing a sealed seam. If these process steps are carried out one after the other in the sequence described above, i.e., the sealing of the bag is only carried out after the neck of the bag has been cut off, it is possible to produce the sealed seam on the already shortened end of the bag, which is no longer under tension. This makes it possible to produce a very precise, in particular straight, seal seam. The other variant, according to which the bag neck is cut off and the bag is sealed at the same time, may offer the advantage of shorter production intervals. The heating of the sealing bar to produce the sealing seam can be controlled by means of a controlled energization of the sealing bar in such a way that the sealing bar produces the sealing seam either with a time delay or at the same time as the bag neck is cut off.

As an alternative to the variant described above, according to which the sealing bar is used both for clamping and for sealing the bag, it would be conceivable for both clamping devices to be present as clamping devices designed separately from the sealing bar. In this variant, the sealing bar would be used as a separate sealing tool between the two clamping devices. This separate structure is useful for the use of sealing bar geometries that are unsuitable for clamping the bag. In addition, this variant leads at best to a structurally simpler design of the tensioning device, because it can then be adjusted together with the sealing bar, for which a common adjustment drive would be sufficient. In this context, it would be conceivable, for example, for the tensioning device to be configured as a tool preceding the sealing bar with a certain projection. The separate structure of the sealing bar from the clamping devices also makes it possible in particular for the sealing bar to be kept at a predetermined temperature level or not to cool down below a predetermined temperature level, from which it can reach a temperature level required for producing the sealing seam more quickly. This ensures energy-efficient operation of the scaling bar.

Preferably, a recess is provided for the tensioning device, into which the tensioning device can be pressed per tensioning stroke. This allows the clamped bag section to be sufficiently tensioned. It would be conceivable for the recess to be formed in a counter-pressure bar opposite the tensioning device or in the sealing bar for an opposing tensioning device. In the latter alternative, the tensioning device and the sealing bar are separate from each other and installed opposite each other. For example, the sealing bar can be integrated in the structure of a tool upper part and the tensioning device in the structure of a tool lower part or vice versa. In all variants, the recess can form a space into which the clamped bag section can be pressed by means of the tensioning device. As the material is fixed in place by the clamping devices, it is stretched by the tensioning device plunging into the recess. The bag neck can then be separated particularly reliably in the area of the stretched bag section. The recess can be in the form of a notch or a slit-shaped opening into which the bag material can be pressed between the clamping points by means of the tensioning device for the purpose of stretching it.

In particular, the cutting device separates the bag in such a way that the separated, superfluous bag neck contains the bag section that has come into contact with the tensioning device.

One variant provides that a recess is provided for the cutting device, into which the cutting device can be pressed per cutting stroke, in particular per sealing stroke. This recess can be in the form of a notch or a slot-shaped opening along which a cutting line to be produced by the cutting device can be precisely produced. It would be conceivable for the recess for the cutting device to be formed by the recess for the tensioning device, into which the tensioning device and the cutting device can be pressed in successively per work cycle in order to cut off the fixed and stretched bag material. This also favors a very compact design.

According to one embodiment of the disclosure, the tensioning device is mounted so as to be height-adjustable relative to the sealing bar by means of an actuator. This variant can be used, for example, with the embodiment in which the sealing bar is used both as a clamping device and for sealing the bag. For example, after the bag section has been clamped by means of the sealing bar, the tensioning device could be adjusted by means of the actuator from a first, retracted or retracted position to a second, extended position in order to tension the clamped bag section. A pneumatic or electric (linear) drive is particularly suitable as an actuator. It would also be conceivable to couple the actuator to at least the tensioning device via a gearbox.

It is conceivable that the tensioning device and the cutting device can be adjusted together by means of the actuator, whereby the tensioning device is present as a tensioning device preceding the cutting device in order to stress the fixed bag section with a predetermined elongation before the cutting process takes place. One variant provides for a lead of the preceding tensioning device to be adjustable in order to vary the degree of elongation for the separation process.

It is conceivable that the actuator used to adjust the tensioning device comprises a force limiter so that a predetermined tensioning force can be reliably achieved in the clamped bag section.

According to one embodiment, the tensioning device is designed as a tensioning device preceding the sealing bar, in particular a spring-loaded tensioning device. This variant is particularly cost-effective to manufacture because the tensioning device can be adjusted and the sealing bar and cutting device can be adjusted by means of a single actuator. A tensioning device preceding the sealing bar is possible in particular in connection with the variant described above, in which both clamping devices are present as clamping devices designed separately from the sealing bar. In this variant, for example, the tensioning device preceding the sealing bar could be coupled to the movement of the sealing bar, i.e., it could be adjusted without an additional actuator.

An advantageous variant provides for the tensioning device to comprise at least one tensioning element that can be pressed into the clamped bag section to exert the tensioning force. Such a tensioning element can, for example, be in the form of a vertically mounted sheet metal strip that can be adjusted up and down, in the form of individual pressure pins, especially those arranged in a row, in the form of a comb, in the form of a horizontally tensioned wire and/or in the form of a silicone profile. In this context, it would be conceivable for the tensioning element to be used in a preceding work interval not only for tensioning the clamped bag section but also as a tool for making openings in the bag neck in order to prepare it with openings for an evacuation and/or gas flushing process. For this optional application, the tensioning element could be configured at least in sections in the form of a comb.

According to one embodiment of the disclosure, the cutting device comprises a current energizable, i.e., heatable, cutting wire, whereby the stretched bag section can be better separated. In particular, the cutting wire can be heated at intervals. In particular, the separating wire can be arranged directly next to the sealing bar, e.g., between the sealing bar and the outer clamping device. It would be expedient to arrange the cutting wire as an integral part of the sealing tool directly next to the sealing bar formed on it, so that the cutting line can be produced directly next to the sealing seam produced by means of the sealing bar. This allows bags to be produced where the bag end is directly adjacent to the sealing seam. This means that there are no open ends that are suitable as a collection point for contaminants.

Conveniently, the energization of the cutting wire can be timed so that the cutting wire has reached a desired temperature level for cutting off the stretched bag section, for example 100° C., and has thus carried out the cutting process before the sealing bar begins to produce the scaling seam. This means that a cut bag end is already available for the production of the seal seam, i.e., bag material that is no longer stretched. This makes the production of the sealed seam particularly precise.

One variant of the disclosure provides that the cutting device comprises a cutting geometry that is formed directly on the sealing bar and can be heated to cut off the bag neck. This cutting geometry can, for example, be in the form of a tapered geometry formed on the sealing bar, e.g., as a knife tip, which can be pressed into the stretched bag material next to the sealing seam to be produced in order to cut off the stretched bag neck before sealing or after sealing. The cutting geometry is preferably heatable. A heating device can be used for this purpose, which is also used to heat the sealing bar. This means that the cutting geometry is available as a heated cutting tool in order to cut through the stretched bag material, in particular preceding the sealing process.

In particular, at least one of the clamping devices is spring-loaded. This makes it possible to configure the two clamping devices as clamping devices preceding the tensioning device, the cutting device and/or the sealing device, whereby a separate stroke for the following unit or following units is not necessary, i.e., their action is automatically delayed after the clamping of the bag section by continued spring compression. This allows the bag section to be reliably clamped for the subsequent clamping, separating and/or sealing process.

It is conceivable that an elastic counter-pressure profile, for example a silicone cord, is present on at least one of the two clamping devices. This makes it possible, in particular, to clamp the bag gently, especially in a non-slip manner, so that no marks are made on it and, in particular, an exact separation line is created. Preferably, at least one of the clamping devices comprises at least one contact pressure element made of plastic, e.g., silicone, on one side used for clamping the bag, or is at least partially made of plastic. These designs also promote gentle clamping of the bag, so that no marks are made on it, and in particular prevent the bag from slipping during clamping or tensioning.

An expedient variant provides for at least one of the two clamping devices to be adjustable by means of an actuator for exerting a predetermined clamping force to fix the bag section. This actuator can be equipped with a force limiter for this purpose.

According to a variant of the disclosure, the chamber machine comprises a discharge device, in particular a blowing device and/or a suction device, for removing the separated bag neck. This allows the separated pouch necks to be removed quickly, so that work intervals on the chamber machine can run more quickly one after the other. This also makes the chamber machine more suitable for fully automated operation.

In particular, the chamber machine is configured for evacuating and/or gas flushing the bag. This makes it possible to pack the products contained in the bags in a desired atmosphere.

One variant provides for the clamping devices, the cutting device and/or the tensioning device to be present either as integral components of a tool upper part or as integral components of a tool lower part. In particular, the chamber machine can comprise a height-adjustable tool upper part on which the clamping devices, the sealing bar, the cutting device and the tensioning device are provided as integral components. This structure is particularly independent of whether one of the two clamping devices is formed by the sealing bar or whether the sealing bar is present as a sealing bar formed separately from the clamping devices. The tool upper part can form a chamber in the form of a lid together with the tool lower part, within which sealed and shortened bags can be produced.

In an advantageous embodiment, the chamber machine is configured in the form of a chamber belt machine. The chamber belt machine preferably has a conveyor belt which can be used to transport open bags loaded with product. In particular, the conveyor belt is designed to convey the bags into a chamber which can be closed for closing the bags and to convey sealed bags produced therein out of the chamber again, so that open bags can be fed in and sealed bags can be removed without manual intervention by an operator.

The disclosure also relates to a packaging line comprising at least one chamber machine according to the disclosure and a shrinking and drying device. The chamber machine, in particular in the form of a chamber belt machine, the shrinking and drying device can be positioned one behind the other in this sequence in the direction of production.

The disclosure further relates to a method for separating off a superfluous bag neck present on a bag filled with a product, wherein a bag section of the bag is clamped for separating off the bag neck by means of mutually spaced clamping devices. According to the disclosure, a tensioning device positioned between the clamping devices exerts a tensioning force on the clamped bag section in order to tension the clamped bag section for a cutting device. As the clamped bag section is loaded by means of the tensioning device at a point between the clamping devices, the clamped bag section stretches. As a result of the stretching, the material, especially elastic material, can be cut more easily. This makes it easier to reliably cut through the bag neck, i.e., to shorten the bag to a desired bag size.

It would be conceivable for one of the two clamping devices to be formed by a sealing bar, whereby the clamping of the bag section, the tensioning of the clamped bag section and the cutting of the bag neck, in particular also the sealing of the bag, are carried out in successive steps. In this particular case, by carrying out the clamping of the bag section, the tensioning of the clamped bag section, the cutting of the bag neck and the sealing of the bag in this sequence in successive steps, it is possible to cut through the tensioned bag material and only then produce the sealed seam in the already shortened material, i.e., material that is no longer under tension. This favors the production of a very high quality seal seam. In the other special application, where the bag neck is cut off and the bag is sealed at the same time, shorter production intervals are possible.

One variant provides for the tensioning device to be at least partially pressed into a recess in order to exert the tensioning force on the clamped bag section. This means that the clamped bag section can also be pressed into the recess, i.e., extended or stretched by immersing it in the recess, which allows elastic bag material in particular to be stretched for the separation process. The stretched bag material can then be reliably cut using the cutting device.

### BRIEF DESCRIPTION OF THE DRAWINGS

The disclosure is explained in more detail with reference to embodiments shown in the figures.

FIG. 1 is a schematic perspective view of a chamber machine,

FIG. 2 shows an isolated device of the chamber machine for cutting to length and sealing a bag transported into it in a first, open position,

FIG. 3 shows the device from FIG. 2 in a second, closed position, and

FIG. 4 is a schematic representation of a packaging line.

Identical components are given the same reference signs throughout the figures.

### DETAILED DESCRIPTION

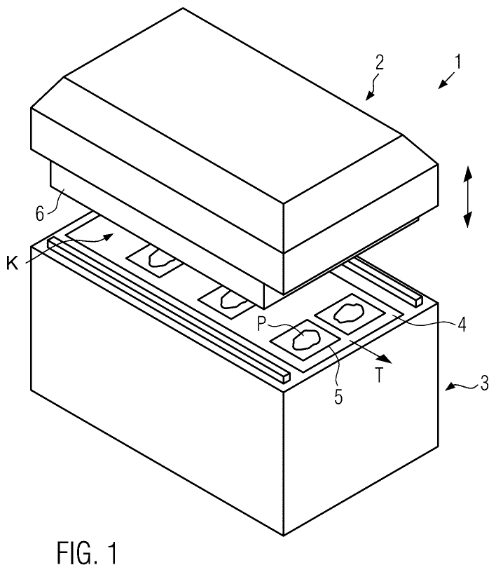

FIG. 1 shows a chamber machine 1 in a schematic perspective view. The chamber machine 1 comprises a tool upper part 2 and a tool lower part 3. The tool upper part 2 and the tool lower part 3 are designed so that they can be moved relative to each other. For example, the lower tool part 3 is in a fixed position and the upper tool part 2 is mounted so that it can move towards and away from the lower tool part 3. However, it may also be provided that the upper tool part 2 is fixed and the lower tool part 3 is mounted so as to be movable relative to the upper tool part 2. Alternatively, it is also possible that both the tool upper part 2 and the tool lower part 3 are arranged so that they can move towards and away from each other.

According to FIG. 1, the lower tool part 3 comprises a transport device 4 for transporting at least one package to be sealed in the form of a bag 5 with a product P inserted therein, e.g., inserted meat or inserted cheese. The transport device 4 can, for example, be designed as a conveyor belt for feeding open bags and discharging sealed bags. In particular, several bags 5 can be transported into and out of a sealable chamber K of the chamber machine 1 side by side and one behind the other in transport direction T by means of the transport device 4.

FIG. 1 also shows a sealing device 6, which is arranged on the tool upper part 2. According to FIG. 1, the tool upper part 2 is mounted in a height-adjustable manner, so that the sealing device 6 mounted thereon is designed to seal the bags 5 positioned inside the chamber K.

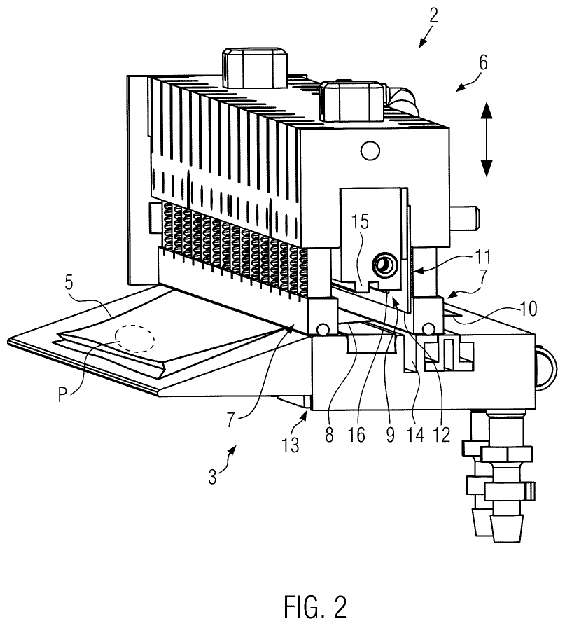

FIG. 2 shows a part of the sealing device 6 in an isolated view. In FIG. 2, the sealing device 6 is in a first position, in which a bag 5 fed to the sealing device 6 is fixed by means of two spring-loaded clamping devices 7. A bag section 8 of the bag 5 is clamped between the two clamping devices 7, which press on the bag 5 at a distance from each other.

To cut off a superfluous bag neck 10 of the bag 5, the sealing device 6 has a cutting device 9. The cutting device 9 is positioned between the clamping devices 7 so that the bag neck 10 can be cut off by means of the cutting device 9 within the bag section 8 clamped by means of the spaced clamping devices 7.

As an aid for the cutting device 9, the sealing device 6 has a tensioning device 11, which is also positioned between the clamping devices 7. In FIG. 2, the tensioning device 11 is in the form of a vertically mounted sheet metal strip comprising a blunt abutting edge 12 facing the clamped bag section 8.

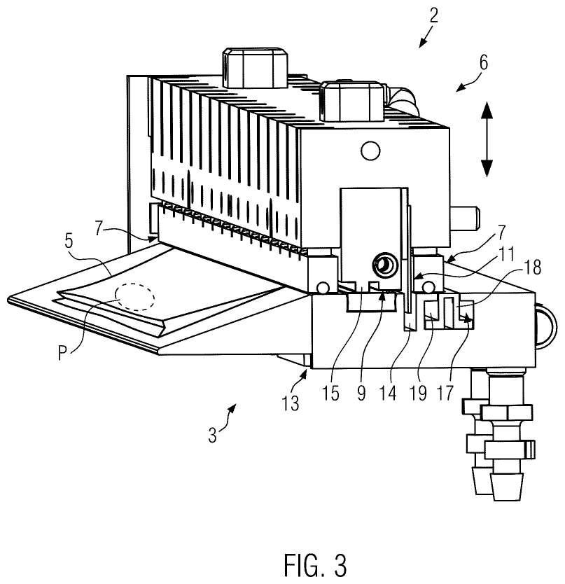

The lower part of the tool 3 has a counter-pressure bar 13 with a recess 14 into which the tensioning device 11 can be pressed per tensioning stroke in order to stretch the clamped bag section 8 (see FIG. 3). FIG. 2 also shows a sealing bar 15 between the two clamping devices 7. The sealing bar 15 is configured to produce a sealed seam on the bag 5.

In the embodiment shown in FIG. 2, the clamping devices 7 are separate clamping devices 7 from the sealing bar 15. FIG. 2 further shows that the tensioning device 11 is designed as a tensioning device 11 preceding the cutting device 9 and the sealing bar 15. This allows the clamping or stretching of the bag section 8 clamped by the clamping devices 7 to be carried out before the excess bag neck 10 is cut off and also before the bag 5 is sealed, if the two clamping devices 7 are retracted further against the suspension, i.e., the sealing device 6 is moved from the position shown in FIG. 2 to the position shown in FIG. 3.

In the structure shown in FIG. 2, it would also be conceivable that the cutting device 9 is configured as a cutting device 9 preceding the sealing bar 15. This makes it possible, using the structure shown in FIG. 2, to carry out the tensioning of the clamped bag section 8, the severing of the bag neck 10 and the forming of the sealing seam by means of the sealing bar 15 in this sequence in successive steps, so that the severing of the bag neck 10 takes place when the clamped bag section 8 is tensioned, with the forming of the sealing seam by means of the sealing bar 15 being carried out at a subsequent time when the cut-to-length bag material is no longer under tension.

In view of the embodiment shown in FIG. 2, according to which the cutting device 9 and the sealing bar 15 are mounted at approximately the same height, simultaneous cutting of the bag neck 10 and production of the sealed seam would be conceivable.

In FIG. 2, the cutting device 9 has a cutting wire 16. The cutting wire 16 can be energized in order to be brought to a desired temperature level. The cutting wire 16 runs parallel to the sealing bar 15 and, in contrast to the illustration shown in FIG. 2, can also be positioned closer to the sealing bar 15 in order to produce a separation line on the bag 5 for separating the bag neck 10 directly next to a sealing seam to be produced by means of the sealing bar 15. Instead of the cutting wire 16, however, another cutting geometry, in particular a heatable blade, could also be considered.

FIG. 3 shows the sealing device 6 in a second position, in which it is maximally brought together with the counter-pressure bar 13 of the lower tool part 3. As a result, the spring-loaded clamping devices 7 are retracted, whereby the bag section 8 can be clamped with sufficient clamping force. In FIG. 3, the tensioning device 11 is immersed in the recess 14, whereby the bag material clamped between the clamping devices 7 is pressed into the recess 14 and thus extended between the clamping devices 7. When a desired elongation is reached, the cutting wire 16 of the cutting device 9 is energized in order to cut off the excess bag neck 10. At the same time or with a time delay, the sealing seam is produced by means of the sealing bar 15.

After sealing, the sealing device 6 shown in FIG. 3 is moved upwards to release the bag neck 10, which is still clamped but has already been separated. The separated bag neck 10 can then be transported away by means of a discharge device 17, which is shown in FIG. 3 as a blow-out bar 18, e.g., blown into an outer shaft of the chamber machine 1. For this purpose, the blow-out bar 18 shown in FIG. 3 can be lifted under compressed air load from a receptacle 19 formed for it in the counter-pressure bar 13 up to the stop in order to blow the separated bag neck 10 away to the side.

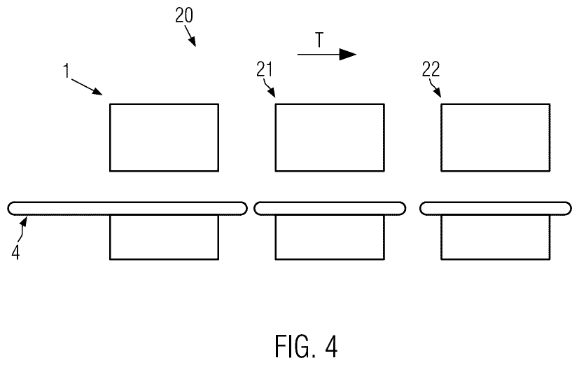

FIG. 4 shows a schematic representation of a packaging line 20 comprising a chamber machine 1 in the form of a chamber belt machine and, behind it in the production direction T, a shrinking device 21 and a drying device 22. The shrinking device 21 can in particular be in the form of a shrink tunnel, through which sealed bags 5 can be transported from the chamber machine 1, in particular transported in a continuous run, the sealed bags 5 being sprayed with hot water in the shrink tunnel. The drying device 21 can be configured as a drying tunnel, in which the shrink-wrapped bags 5 coming from the shrink tunnel 21 can be dried in a continuous run by blowers with cold air.

What is claimed is:

1. A chamber machine for cutting to length a bag filled with a product, the chamber machine comprising a cutting device for cutting off a superfluous bag neck and two mutually spaced-apart clamping devices for clamping a bag section, the cutting device is positioned between the clamping devices so that the cutting of the bag neck can be carried out by the cutting device within the bag section clamped by the spaced-apart clamping devices, wherein the chamber machine further comprises a tensioning device positioned between the clamping devices for exerting a tensioning force on the bag section clamped by the spaced-apart clamping devices.

2. The chamber machine according to claim 1, wherein at least one of the two clamping devices is formed by a sealing bar or both clamping devices are present as clamping devices formed separately from the sealing bar.

3. The chamber machine according to claim 1, wherein a recess is provided for the tensioning device, into which recess the tensioning device can be pressed per tensioning stroke, and/or a recess is provided for the cutting device, into which recess the cutting device can be pressed per cutting stroke.

4. The chamber machine according to claim 2, wherein the tensioning device is mounted so as to be vertically adjustable relative to the sealing bar by an actuator.

5. The chamber machine according to claim 2, wherein the tensioning device comprises a spring-loaded tensioning device preceding the sealing bar.

6. The chamber machine according to claim 1, wherein the tensioning device comprises at least one tensioning element that can be pressed into the clamped bag section to exert the tensioning force.

7. The chamber machine according to claim 1, wherein the cutting device comprises a cutting wire that can be energized and/or that the cutting device comprises a cutting geometry that is formed directly on a sealing bar and can be heated to sever the bag neck.

8. The chamber machine according to claim 1, wherein at least one of the clamping devices is spring-loaded, at least one of the clamping devices has an elastic counter-pressure profile and/or at least one of the clamping devices on a side used to clamp the bag comprises at least one pressing element made of plastic or is at least partly made of plastic.

9. The chamber machine according to claim 1, wherein the chamber machine comprises a discharge device for removing the cut bag neck.

10. The chamber machine according to claim 9, wherein the discharge device comprises a blowing device and/or a suction device.

11. The chamber machine according to claim 1, wherein the chamber machine is configured for evacuating and/or gassing the bag.

12. The chamber machine according to claim 1, wherein the clamping devices, the cutting device and/or the tensioning device are either present as integral components of a tool upper part or as integral components of a tool lower part.

13. The chamber machine according to claim 1, wherein the chamber machine is configured as a chamber belt machine.

14. A packaging line comprising the chamber machine according to claim 1 and a shrinking device and a drying device.

15. A method for severing an excess bag neck present on a bag filled with a product, the method comprising:
clamping a bag section of the bag for the severing of the bag neck by two clamping devices spaced apart from one another; and
exerting a tensioning force on the clamped bag section by a tensioning device positioned between the clamping devices in order to tension the clamped bag section for a cutting device.

16. The method according to claim 15, wherein one of the two clamping devices is formed by a sealing bar or both clamping devices are formed as clamping devices that are separate from the sealing bar, wherein the clamping of the bag section, the tensioning of the clamped bag section and the severing of the bag neck are carried out in temporally successive steps.

17. The method according to claim 16, further comprising sealing the bag with the sealing bar.

18. The method according to claim 15, wherein the tensioning device for exerting the tensioning force on the clamped bag section is pressed into a recess.
